(19) United States
(12) Patent Application Publication
(10) Pub. No.: US 2007/0181768 A1
(43) Pub. Date: Aug. 9, 2007

(54) Rotational apparatus of display

(75) Inventors: Dong-Won Choi, Suwon-si (KR); Chil-Sung Lee, Suwon-si (KR); Jae-Kyung Kim, Ansan-si (KR); Sang-Min Woo, Suwon-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MACHANICS CO., LTD, Suwon (TW)

(21) Appl. No.: 11/653,449

(22) Filed: Jan. 16, 2007

(30) Foreign Application Priority Data
Jan. 16, 2006 (KR) 10-2006-0004475

(51) Int. Cl. F16M 13/00

(52) U.S. Cl. 248/415

(57) ABSTRACT

The present invention is to provide a motor having a swivel hinge preventing the damage of the deceleration gear and the rotor of the motor, and the rotation apparatus of a display having the same. In one aspect, the invention features a rotation apparatus of a display, which comprises a stand, a swivel hinge having one end fixed to the stand and configured to rotate relatively when a predetermined amount of torque is applied, a motor joined to the other end of the swivel hinge by a shaft and having a deceleration gear, and a guide configured to rotates as a single body with the motor and joined to a display, wherein the restrictive torque of the swivel hinge is smaller than the constraint force of the deceleration gear and greater than the weigh of the display.

### CROSS-REFERENCE TO RELATED APPLICATIONS

This application claims the benefit of Korean Patent Application No. 10-2006-0004475 filed with the Korean Intellectual Property Office on Jan. 16, 2006, the disclosure of which is incorporated herein by reference in its entirety.

### BACKGROUND

1. Technical Field

The present invention relates to motor having swivel hinge and rotation apparatus of a display automatically and manually using the motor.

2. Description of the Related Art

As the size and weigh of display such as computer monitor or television are increased, rotation apparatus able to rotate the display is widely used. The rotation apparatus uses a motor and cam make the display pointed toward a user.

FIG. 1 is a schematic diagram of a conventional rotation apparatus of a display. Referring to FIG. 1, conventional rotation apparatus of a display includes a stand 11 fixed to a floor and a motor 13 having one end fixed to the stand 11 and the other end joined to a display 15. The motor 13, not illustrated, joined to an external apparatus and makes the user control the position of the display using a remote controller and so on. And the motor 13 has deceleration gears in its interior because it is necessary to rotate the display 15 having large weigh slowly.

Though the rotation apparatus of a display uses power supply to drive the motor 13, it is necessary the user rotate the display manually when there is no power supply to the rotation apparatus. If the display 15 is rotated manually, a shaft 17 connects the display 15 and the motor 13 is rotated simultaneously. In that reason the deceleration gear and the rotor of the motor 13 are damaged.

### SUMMARY

The present invention is to provide a motor having a swivel hinge preventing the damage of the deceleration gear and the rotor of the motor, and the rotation apparatus of a display having the same.

In one aspect, the invention features a rotation apparatus of a display, which comprises a stand, a swivel hinge having one end fixed to the stand and configured to rotate relatively when a predetermined amount of torque is applied, a motor joined to the other end of the swivel hinge by a shaft and having a deceleration gear, and a guide configured to rotates as a single body with the motor and joined to a display, wherein the restrictive torque of the swivel hinge is smaller than the constraint force of the deceleration gear and greater than the weigh of the display.

Embodiments may include one or more of the following features. For example, the swivel hinge has a first rotation part and a second rotation part configured to rotate relatively and a friction part interposed between the first rotation part and the second rotation part, the stand has an insertion hole into which the first rotation part is inserted and fixed, and the shaft is connected to the second rotation part.

The stand cam have a rotation hole having a rotation angle in the center of the insertion hole, and a fixing member is inserted into the rotation hole and fixed to the guide. And a bearing can be interposed between the guide and the stand and/or between the stand and the fixing member.

In one aspect, the invention features a rotation apparatus of a display, which comprises a stand, a motor having one end fixed to the stand and having a deceleration gear, a swivel hinge joined to the shaft of the motor and configured to rotates relatively when a predetermined amount of torque is applied, and a guide joined to the swivel hinge and configured to rotate simultaneously with a display, wherein the restrictive torque of the swivel hinge is smaller than the constraint force of the deceleration gear and greater than the weigh of the display.

Embodiments may include one or more of the following features. For example, guide can have a fixing groove into which the swivel hinge is inserted and fixed, and the stand has a motor fixing groove into which the motor is inserted and fixed. The stand has a rotation hole having a rotation angle in the center of the insertion hole, and a fixing member is inserted into the rotational hole and fixed to the guide. A bearing can be interposed between the guide and the stand and/or between the stand and the fixing member.

In one aspect, the invention features a motor assembly, which comprises a swivel hinge configured to rotate relatively when a predetermined amount of torques is applied, and a motor joined with one end of the swivel hinge by a shaft and having a deceleration gear, wherein the restrictive torque of the swivel hinge is smaller than the constraint force of the deceleration gear.

And the swivel hinge has a first rotational part fixed to the axis of the deceleration gear and configured to rotate simultaneously, a second rotation part inserted rotatably into the first rotation part, a friction part interposed between the first rotation part and the second rotation part, and a pressure part inserted into the first rotation part and configured to press the second rotation part toward the friction part.

### BRIEF DESCRIPTION OF THE DRAWINGS

FIG. 1 is a schematic diagram of a conventional rotation apparatus of a display.

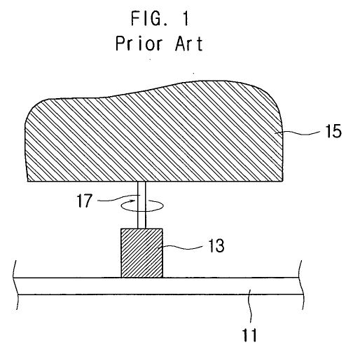

FIG. 2 is a cross sectional view of a rotation apparatus of a display in accordance with the first embodiment of the invention.

FIG. 3 is a plan view of a fixing member inserted into a stand in accordance with a first embodiment of the invention.

FIG. 4a is a schematic diagram of the display and motor rotating, when the rotation apparatus of the display presented in FIG. 2 rotate automatically.

FIG. 4b is a schematic diagram of the display, motor and swivel hinge rotating when the rotation apparatus of the display presented in FIG. 2 is rotate automatically.

FIG. 5 is a cross sectional view of the other embodiment of a rotation apparatus of a display.

FIG. 6a is a schematic diagram of the display, swivel hinge and motor rotating when the rotation apparatus of display presented in FIG. 5 is rotated automatically.

FIG. 6b is a schematic diagram of the display rotating when the rotation apparatus of the display presented in FIG. 5 is rotated manually.

FIG. 7 is a schematic diagram of motor assembly of the first embodiment of the present invention.

### DETAILED DESCRIPTION

Hereinafter, an embodiment of a rotation apparatus of a display according to the present invention will be described in more detail with reference to the accompanying drawings.

Embodiments of the rotation apparatus of a display according to the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

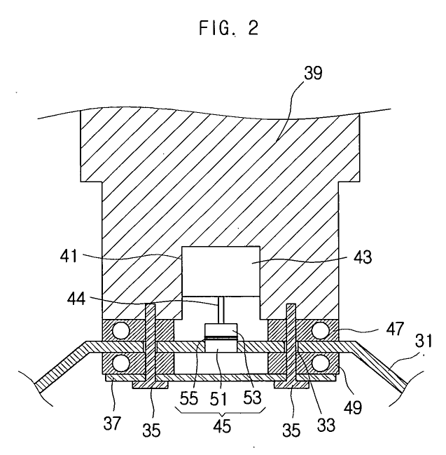

Referring to FIG. 2, the rotation apparatus of a display in accordance with the first embodiment comprises guide 39 provide the display (unseen) a turning effect, a motor 43 fixed to the guide 39 and configured to provide the guide 39 a driving force when rotated automatically, a stand 31 fixed to a floor and a fixing member 35 inserted into the stand 31 and joined to the guide 39. And a bearing 47, 49 is interposed between the guide 39 and the stand 31 or the guide 39 and a bracket 37. A swivel hinge 45 is inserted and connected to the motor 43.

The rotation apparatus of a display in accordance of the present invention is characterized in having swivel hinge 45 preventing the damage of the rotor of the motor and a deceleration gear when rotated manually. In other words, if the rotation apparatus of a display is rotated manually, the guide 39, fixing member 35, the bracket 37 and motor 43 is configured to rotate as a single body, slip is occurred between a first rotation part 51 and a second rotation part 53 of the swivel hinge 45 and the second rotation part 53 is rotated. But the deceleration gear and rotor of the motor don't be rotated. And if the rotation apparatus of a display is rotated automatically by the driving force of the motor 43, the swivel hinge 45 doesn't rotate and only the guide 39, the fixing member 35, the bracket 37 and the motor 43 are rotated. Consequently, when the rotation apparatus of a display is rotated manually the deceleration gear, not illustrated, doesn't rotate, so the damage of the deceleration gear and rotor is prevented.

The guide 39, as illustrated in FIG. 2, is rotated with the motor 43, the bracket 27 and fixing member 35 at the time of automatic rotation by the driving force of the motor 43. And the guide 39 is rotated with the motor 43, bracket 37, swivel hinge 45 and fixing member 35 at the time of manual rotation by the a user. A display, not illustrated, such as television or monitor is positioned at the guide 39 and the direction of the display is determined by the rotation of the guide 39.

A motor insertion hole 41 is formed at the center of the guide 39. The motor 43 is inserted into the insertion hole 41 and configured to rotate with the guide 39 as a single body. The motor insertion hole 41 is the center of the rotation of the display and guide 39. And the fixing member 35 is fixed along the circumference of the motor insertion hole. Accordingly guide 39 is rotated with the fixing member 35 at the time of the manual rotation as well as the automatic rotation.

An upper bearing 47 is interposed between the guide 39 and the stand 31 and configured to make the rotation of the guide smooth.

The guide 39 can be shaped in circle plate or rectangular plate. And if the display is positioned or fixed, the shape of the guide 39 doesn't matter. Besides the guide is formed with the display as single body in accordance with design specifications.

The stand 31 is fixed to a floor or a wall and configured to support the rotation apparatus of a display. An insertion hole 32 is formed in the center of the stand 31 and the swivel hinge 45 is inserted and fixed to the insertion hole 32. The insertion hole 32 is in connection with the insertion hole of the guide 39, and the insertion hole 32 of the stand 31 and the motor insertion hole 41 are the center of the rotation apparatus of a display.

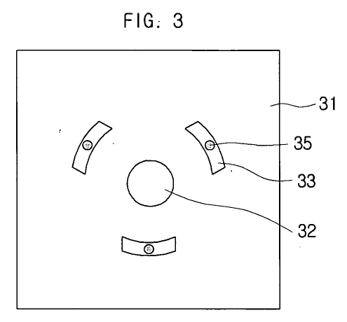

Along the circumference of the insertion hole 32, as illustrated in FIG. 3, rotation holes 33 are formed. The rotation holes 33 have the same central angle. And fixing member 35 is inserted into the rotation hole 33. So that, fixing member 35 rotated with the guide 39 as a single body is guided by the rotation hole 33 and the angle of the fixing member 35 and guide 39 can rotate is determined by the central angle.

The motor 43 is inserted and fixed to the insertion hole 41 of the guide 39 and configured to rotate as a single by with the guide 39. The motor 43 has a shaft 44 joined to the swivel hinge 45 and configured to provide turning effect. And the motor 43 has a deceleration gear(unseen) to decrease the speed of revolution of the display and to increase the torque. The deceleration gear comprises a gear train to decrease the high speed of the turning effect caused by the motor 43 and to get the greater torque.

The motor 43 has a predetermined amount of drive torque. The drive torque of the motor 43 is the torque of the output shaft when current is supplied to the motor 43. And the drive torque of the motor 43 can be greater than the weigh of the display and fixing force (the force between the guide 39 and fixing member 35). And the deceleration gear has restrictive torque and it doesn't drive when a torque smaller than the restrictive torque is applied through the shaft.

The motor 43 can be DC motor or AC motor can provide the swivel hinge 45 a turning effect.

The swivel hinge 45 comprises a first rotation part 51 inserted and fixed to the insertion hole 32 of the stand 31 and a second rotation part 53 joined to the shaft and the first rotation part 53 slidably. The first rotation part 51 is fixed to the stand 31 and the second rotation part 53 is fixed to the shaft 44. Between the first rotation part 51 and the second rotation part 53, there is a friction part 55 by which the restrictive torque of swivel hinge 45 is occurred. Consequently, though a torque smaller than restrictive torque is applied to the swivel hinge 45, the first rotation part 51 doesn't rotate relatively to the second rotation part 53.

The restrictive torque of the swivel hinge 45 is greater than the weigh of the display and fixing force (fixing force between the guide 39 and the fixing member 35). Consequently, in accordance with the rotation apparatus of a display of one embodiment of the present invention, the one end of the output shaft 44 is constrained by the weigh of the display and fixing force (fixing force between the guide 39 and fixing member 35) and the other end is constrained by the swivel hinge 45. So that, if current is applied to the motor 43 and the drive torque is applied to the output shaft 44, guide including display are rotated because the restrictive torque of the swivel 45 is greater than the weigh and fixing force of the display.

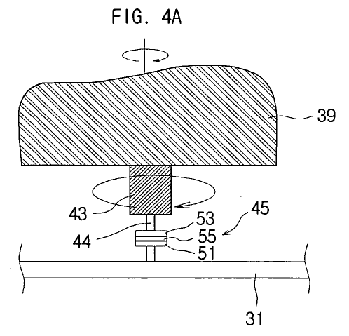

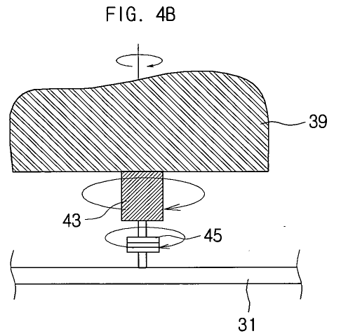

Consequently, at the time of the automatic rotation of the motor, the swivel hinge 45 is fixedly inserted into the stand 31, as illustrated in FIG. 2 and FIG. 4a, configured to rotate with the motor 43, guide 39, fixing member 35 and bracket 37 as single body. Though the motor 43 of the rotation apparatus of a display provide friction part 55 drive force through the shaft 44, as explained above, restrictive torque of the friction part 55 is greater than the weigh of the display and fixing force, so that the first rotation part 51 and the second rotation part 53 doesn't rotate but display including motor 43 are rotated relatively.

The restrictive force of the motor 43 is greater than the constraint torque of the swivel hinge 45. Consequently, a torque greater than the constraint torque of the swivel hinge 45 and constraint force is applied to the display or guide 39, the second rotation part 53 is rotated relatively to the first rotation part 51 but the deceleration gear and the rotor of the motor don't be rotated. Accordingly, a torque greater than the constraint torque of the swivel hinge 45 and constraint force is applied by the user, as illustrated in FIG. 4, the second rotation part 53, guide 39, fixing member 35, bracket 37, shaft 44 and motor 43 are rotated as a single body, but the rotor of the motor 43 and deceleration gear aren't rotated. As a consequence, in accordance of the one embodiment of the present invention, at the time of the manual rotation the motor is rotated as a whole but the rotor in the motor 43 and deceleration gear, so that the damage of the deceleration gear and the rotor is prevented.

The fixing member 35 is penetrated through the rotation hole 33 of the stand 31 and inserted fixedly into the lower end of the guide 39. The fixing member 35 is rotated with the guide 39 and bracket 37 and configured to support the guide 39 rotatably about the stand 31. The fixing member 35 is inserted into the rotation hole 33, as illustrated in FIG. 3, and the rotation hole 33 restrict the rotation angle of the fixing member 35.

The bracket 37 is interposed between the fixing member 35 and a lower bearing 49 and configured to support the fixing member 35. The bracket 37 is rotated with the fixing member 35. And the upper bearing 47 is interposed between the stand 31 and the guide 39. The lower bearing 49 makes the rotation of the bracket 37 smooth, and the upper bearing 47 makes the rotation of the guide 39 smooth. The upper bearing 47 and lower bearing 49 can conventional ball bearing and so on.

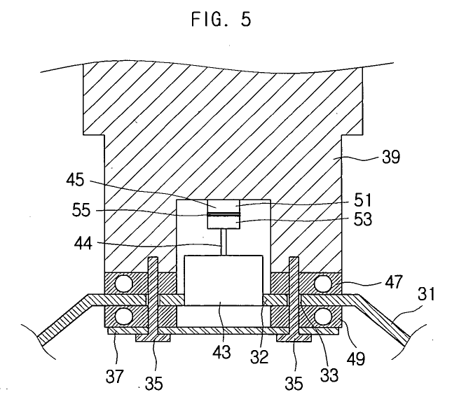

Referring to FIG. 5, rotation apparatus of a display according to the other embodiment of the present invention has the same or similar structure with the above embodiment of the rotation apparatus of a display except that the motor 43 is inserted into the insertion hole 32 of the stand 31 and the swivel hinge 45 is fixed to the guide 39. Accordingly, structural difference is mainly explained below.

The first rotation part 51 of the swivel hinge 45 is fixed and configured to rotate with the guide 39. And the motor 43 is fixedly inserted into the insertion hole 32 of the stand 31. The motor 43 of the present embodiment is joined to the second rotation part 53 and shaft 44.

In the rotation apparatus of a display in accordance with the other embodiment of the present invention, the constraint force of the swivel hinge 45 is smaller than the constraint force of the deceleration gear and greater than the weigh of the display and fixing force. Consequently, present embodiment of the rotation apparatus of a display is worked as below at the time of automatic or manual rotation.

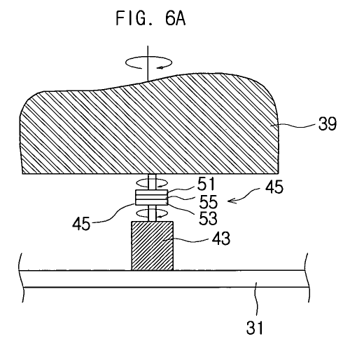

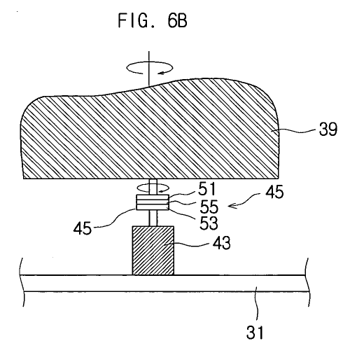

At the time of manual rotation, if a torque greater than the constraint torque of swivel hinge 45 and constraint force is applied, as illustrated in FIG. 5 and FIG. 6b, rotor of the motor 43, deceleration gear and the second rotation part 53 aren't be rotated, but the first rotation part 51 is rotated with the guide 39, fixing member 35 and bracket 37. It is because that a torque greater than the constraint torque of the swivel hinge 45. As a consequence, the rotation apparatus of a display according to the present embodiment is rotated manually; the damage of the deceleration gear and rotor of the motor 43 can be prevented.

At the time of manual rotation of the rotation apparatus of a display according to the present invention, as illustrated in FIG. 6a, the swivel hinge 45, the guide 39, the fixing member 35 and the bracket 35 are rotated simultaneously due to the operation of the motor 43. Because the weigh of the display and the fixing force are smaller than the constraint torque of the swivel hinge 45, the second rotation part 53 aren't rotated relative to the first rotation part 51, so that the whole swivel hinge 45 can be rotated with the guide 39.

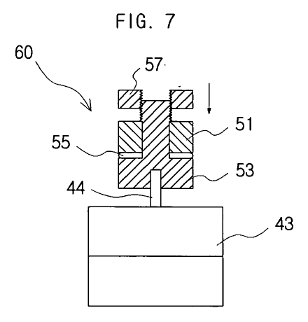

Referring to the FIG. 7, a motor assembly 60 of the one embodiment of the present invention comprises the first rotation part 51, the friction part 55 and the second rotation part 53. And the motor assembly 60 further comprises a the swivel hinge 45 configured to make the first rotation part 51 be rotated relative to the second rotation part 53, and the motor 43 joined with one end of the swivel hinge 45 by the shaft 44 and configured to have the deceleration motor. And the constraint torque of the swivel hinge 45 is smaller than the drive torque of the motor 43 and constraint force of the deceleration.

The swivel hinge 45 comprise the second rotation part 53 fixed to the shaft 44 of the motor 43 and configured to rotate with the shaft 44, and the first rotation part 51 able to rotate relatively to the second rotation part 53. And the swivel hinge 45 further includes the friction part 55 interposed between the first rotation part 51 and the second rotation part 53 and configured to induce a slip of the first rotation part 51 relative to the second rotation part 53. And the first rotation part 51 is pressed to the friction part 55 through the pressure part 57. The pressure part 57 is fixedly inserted into the second rotation part 53 and configured to press the first rotation part 51 to the friction part 55, so that the first rotation part 51 relative to the second rotation part 53 when a slip is occurred in the friction part 55.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A rotation apparatus of a display, the rotation apparatus comprising:
a stand;
a swivel hinge having one end fixed to the stand and configured to rotate relatively when a predetermined amount of torque is applied;
a motor joined to the other end of the swivel hinge by a shaft and having a deceleration gear; and
a guide configured to rotates as a single body with the motor and joined to a display,
wherein the restrictive torque of the swivel hinge is smaller than the constraint force of the deceleration gear and greater than the weigh of the display.

2. The rotation apparatus of claim 1, wherein
the swivel hinge has a first rotation part and a second rotation part configured to rotate relatively and a friction part interposed between the first rotation part and the second rotation part,
the stand has an insertion hole into which the first rotation part is inserted and fixed, and
the shaft is connected to the second rotation part.

3. The rotation apparatus of claim 2, wherein
the stand has a rotation hole having a rotation angle in the center of the insertion hole, and
a fixing member is inserted into the rotation hole and fixed to the guide.

4. The rotational apparatus of claim 1, wherein
a bearing is interposed between the guide and the stand.

5. The rotation apparatus of claim 3,
a bearing is interposed between the stand and the fixing member.

6. A rotation apparatus of a display including, the rotation apparatus comprising;
a stand,
a motor having one end fixed to the stand and having a deceleration gear;
a swivel hinge joined to the shaft of the motor and configured to rotates relatively when a predetermined amount of torque is applied; and
a guide joined to the swivel hinge and configured to rotate simultaneously with a display,
wherein the restrictive torque of the swivel hinge is smaller than the constraint force of the deceleration gear and greater than the weigh of the display.

7. The rotational apparatus of claim 6, wherein
the guide has a fixing groove into which the swivel hinge is inserted and fixed, and
the stand has a motor fixing groove into which the motor is inserted and fixed.

8. The rotational apparatus of claim 7, wherein
the stand has a rotation hole having a rotation angle in the center of the insertion hole, and
a fixing member is inserted into the rotational hole and fixed to the guide.

9. The rotational apparatus of claim 6, wherein
a bearing is interposed between the guide and the stand.

10. The rotational apparatus of claim 6, wherein
a bearing is interposed between the stand and the fixing member.

11. A motor assembly comprising:
a swivel hinge configured to rotate relatively when a predetermined amount of torques is applied; and
a motor joined with one end of the swivel hinge by a shaft and having a deceleration gear,
wherein the restrictive torque of the swivel hinge is smaller than the constraint force of the deceleration gear.

12. The motor assembly of claim 11, wherein
the swivel hinge has a first rotational part fixed to the axis of the deceleration gear and configured to rotate simultaneously, a second rotation part inserted rotatably into the first rotation part, a friction part interposed between the first rotation part and the second rotation part, and a pressure part inserted into the first rotation part and configured to press the second rotation part toward the friction part.
